(19) United States
(12) Patent Application Publication
(10) Pub. No.: US 2025/0279741 A1
(43) Pub. Date: Sep. 4, 2025

(54) MOTOR CONTROL METHOD

(71) Applicant: NIDEC CORPORATION, Kyoto (JP)

(72) Inventors: Atsushi HIGASHIDANI, Kyoto (JP); Tomotsugu SUGIYAMA, Taipei City (TW); Yasunori NAKAMURA, Kyoto (JP); Jianbin LI, Dongguan City (CN); Xiaobin HU, Dongguan City (CN)

(21) Appl. No.: 19/060,891

(22) Filed: Feb. 24, 2025

(30) Foreign Application Priority Data
Mar. 1, 2024 (JP) 2024-031256

(51) Int. Cl. H02P 27/08

(52) U.S. Cl. CPC H02P 27/08

(57) ABSTRACT

A motor control method includes driving a motor in a forward rotational direction at a rotational speed corresponding to a duty cycle range of a first control signal that is a pulse width modulation signal, and when the rotational direction and the rotational speed of the motor correspond to that when the motor is not rotating and a second control signal that is a pulse width modulation signal having a frequency different from a frequency of the first control signal is received, driving the motor in a reverse rotational direction. Thus, the method controls the motor by switching the rotational direction of the motor between the forward rotational direction and the reverse rotational direction with a high degree of freedom to reduce or prevent malfunctioning.

### CROSS-REFERENCE TO RELATED APPLICATIONS

The present application claims priority under 35 U.S.C. § 119 to Japanese Patent Application No. 2024-031256, filed on Mar. 1, 2024, the entire contents of which are hereby incorporated herein by reference.

### 1. FIELD OF THE INVENTION

The present disclosure relates to motor control methods.

### 2. BACKGROUND

For example, in a conventional washing machine, a microcomputer performs control in such a manner that PWM control signals having a duty of 5% to a duty of 20% are sequentially applied to an inverter main circuit at intervals of 5% to energize a stator coil, a brushless motor is alternately driven to perform forward and backward rotation of a stirring body to perform a washing operation, and a PWM control signal having a duty of 5% is applied to the motor to perform reverse braking when the forward and backward rotation drive is switched.

Conventionally, both the PWM control signal for forward and reverse rotational driving and the PWM control signal for applying reverse braking are PWM control signals with a duty of 5%.

However, in the conventional motor control method, since the PWM control signal with a duty of 5% for rotationally driving the motor and the PWM control signal with a duty of 5% for performing reverse rotation control both have a duty of 5%, there is a concern that malfunction occurs, and there is a problem that the degree of freedom of control for rotationally driving the motor is small.

### SUMMARY

An example embodiment of a motor control method of the present disclosure includes driving a motor in a forward rotational direction at a rotational speed corresponding to a duty cycle range of a first control signal that is a pulse width modulation signal, and driving the motor in a reverse rotational direction when the rotational direction and the rotational speed of the motor correspond to that when the motor is not rotating and a second control signal that is a pulse width modulation signal of a different frequency from the first control signal is received.

The above and elements, other features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic diagram illustrating the overall configuration of an example of a motor control method according to an example embodiment of the present disclosure.

FIG. 2 is a schematic diagram explaining a first control signal according to an example embodiment of the present disclosure.

### DETAILED DESCRIPTION

Hereinafter, example embodiments of the present disclosure will be described in detail with reference to the accompanying drawings.

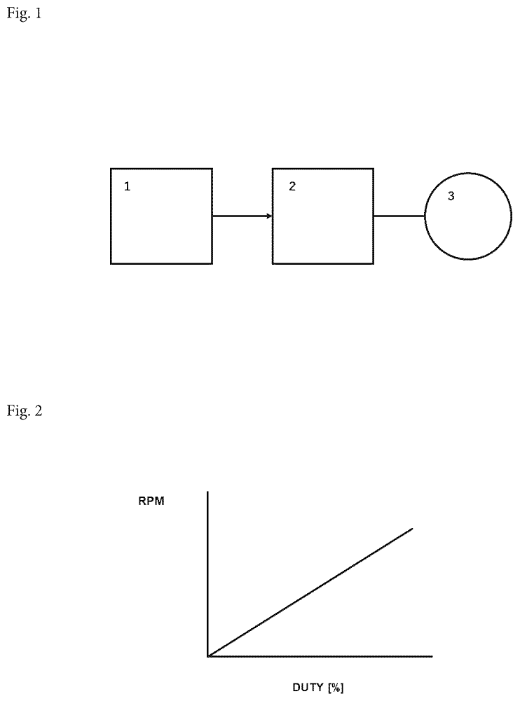

FIG. 1 is a schematic diagram illustrating the overall configuration of an example of a motor control method according to an example embodiment of the present disclosure, and FIG. 2 is a schematic diagram for explaining a first control signal according to the example embodiment of the present disclosure. A motor control method or a corresponding motor control device or motor control system includes a controller 1, a driver 2, and a motor 3.

A first control signal that is a pulse width modulation (PWM) signal and a second control signal that is a pulse width modulation (PWM) signal are transmitted from the controller 1 to the driver 2, and the driver 2 drives the motor 3 based on the received first control signal and second control signal.

Here, the frequency of the first control signal and the frequency of the second control signal are different. For example, the frequency of the first control signal may be 10 kHz to 30 kHz, and the frequency of the second control signal may be 8 Hz to 12 Hz.

As illustrated in FIG. 2, the driver 2 drives the motor 3 in the forward rotational direction at a rotational speed corresponding to the duty cycle range of the first control signal. Here, the horizontal axis in FIG. 2 represents the duty cycle range (unit: %) of the first control signal, and the vertical axis represents the rotational speed (unit: RPM) of the motor 3 in the forward rotational direction.

Here, since the rotational speed 0% in the forward rotational direction of the motor 3 corresponds to the duty cycle range 0%, it is easy to perform control in which the rotational speed in the forward rotational direction of the motor 3 is reduced, and it is easy to perform control by switching the rotational direction of the motor 3 between the forward rotational direction and the reverse rotational direction.

When the rotational direction and the rotational speed of the motor 3 correspond to that the motor 3 is not rotating, and the second control signal is received, the motor 3 is driven in the reverse rotational direction.

As described above, since the frequency of the second control signal for controlling the rotational direction of the motor 3 to the reverse rotational direction is different from the frequency of the first control signal for controlling the rotation of the motor 3 in the forward rotational direction, the rotational direction of the motor is controlled by switching the rotational direction between the forward rotational direction and the reverse rotational direction with a high degree of freedom, and malfunction can be suppressed.

Here, since both the first control signal and the second control signal are pulse width modulation (PWM) signals, the first control signal and the second control signal can be transmitted from the controller 1 to the driver 2 using a common transmission path. When a lead wire is used as a transmission path, the first control signal and the second control signal can be transmitted from the controller 1 to the driver 2 by the common lead wire. Therefore, it is not necessary to provide a lead wire for transmitting the second control signal separately from the lead wire for transmitting the first control signal.

When the motor 3 is driven in the forward rotational direction and the second control signal is received, the motor 3 is driven in the reverse rotational direction. Here, the fact that the motor 3 is driven in the reverse rotational direction means that the rotational speed of the motor 3 in the forward rotational direction decreases, and includes that the motor 3 rotates in the reverse rotational direction after the rotational direction and the rotational speed of the motor 3 correspond to the fact that the motor 3 is not rotating.

In this way, not only when the rotational direction and the rotational speed of the motor 3 correspond to that the motor 3 is not rotating, but also when the motor 3 is driven in the forward rotational direction, the rotational direction of the motor is controlled by switching the rotational direction of the motor between the forward rotational direction and the reverse rotational direction with a high degree of freedom, and malfunction can be suppressed.

When the rotational direction and the rotational speed of the motor 3 correspond to that the motor is not rotating, or when the motor 3 is driven in the reverse rotational direction, the duty cycle range of the received first control signal is greater than 0% and less than 100%. In other words, in the above-described state, a first control signal having the duty cycle range of 0% and a first control signal having the duty cycle range of 100% are not received by the driver 2. Here, “not received by the driver 2” includes “not used for driving or controlling the motor 3 even though it is received by the driver 2” and “not transmitted to the driver 2 by the controller 1”.

In this way, it is possible to prevent erroneous recognition that the second control signal is received by the driver 2 and to prevent erroneous control from being performed, even though the first control signal is received by the driver 2 so as to allow the motor 3 to be driven in the forward rotational direction. Here, for a pulse width modulation (PWM) signal whose duty cycle range is 0% or 100%, it is difficult to clearly identify its frequency. Therefore, preventing a first control signal having the duty cycle range of 0% and a first control signal having the duty cycle range of 100% from being received by the driver 2 in the above-described state contributes to suppression of malfunction.

When the rotational direction and the rotational speed of the motor 3 correspond to that the motor 3 is not rotating or when the motor 3 is driven in the reverse rotational direction, even if a second control signal whose duty cycle range is 0% or 100% is received, the rotational direction and the rotational speed of the motor 3 continue to correspond to that the motor 3 is not rotating, or the motor 3 continues to be driven in the reverse rotational direction.

In this way, it is possible to prevent erroneous recognition that a first control signal is received by the driver 2 and to prevent erroneous control from being performed, even though a second control signal is received by the driver 2 so that the motor 3 is driven in the reverse rotational direction. Here, for a pulse width modulation (PWM) signal whose duty cycle range is 0% or 100%, it is difficult to clearly identify its frequency. Therefore, even if a second control signal having the duty cycle range of 0% and a pulse width modulation (PWM) signal having the duty cycle range of 100% are received by the driver 2 in the above-described state, preventing an erroneous recognition that a first control signal is received by the driver 2 so as to allow the motor to be driven in the forward rotational direction for example and thus preventing the motor from being driven in the forward rotational direction contributes to suppression of malfunction.

The present disclosure is applicable to, for example, a motor and control of a motor.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor control method comprising:
driving a motor in a forward rotational direction at a rotational speed corresponding to a duty cycle range of a first control signal that is a pulse width modulation signal; and
driving the motor in a reverse rotational direction when a rotational direction and a rotational speed of the motor correspond to that when the motor is not rotating and a second control signal that is a pulse width modulation signal having a frequency different from a frequency of the first control signal is received.

2. The motor control method according to claim 1, further comprising, when the motor is driven in the forward rotational direction and the second control signal is received, driving the motor in the reverse rotational direction.

3. The motor control method according to claim 1, further comprising, when the rotational direction and the rotational speed of the motor correspond to that when the motor is not rotating and the second control signal is received, driving the motor in the reverse rotational direction even though a duty cycle range of the received second control signal is in a range from 0% to 100%.

4. The motor control method according to claim 3, wherein when the rotational direction and the rotational speed of the motor correspond to that when the motor is not rotating, or when the motor is driven in the reverse rotational direction, a duty cycle range of a received first control signal is greater than 0% and less than 100%.

5. The motor control method according to claim 3, wherein when the rotational direction and the rotational speed of the motor correspond to that when the motor is not rotating, or when the motor is driven in the reverse rotational direction, the rotational direction and the rotational speed of the motor continue to correspond to that the motor is not rotating or the motor continues to be driven in the reverse rotational direction, even though a pulse width modulation signal in which the duty cycle range is 0% or 100% is received.
